(19) United States
(12) Patent Application Publication
(10) Pub. No.: US 2008/0158494 A1
(43) Pub. Date: Jul. 3, 2008

(54) Multi-domain vertical alignment liquid crystal display

(75) Inventors: Yu-Cheng Lin, Miao-Li (TW); Chun-Yung Chi, Miao-Li (TW); Chueh-Ju Chen, Miao-Li (TW); Chiu-Lien Yang, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 12/005,940

(22) Filed: Dec. 29, 2007

(30) Foreign Application Priority Data
Dec. 29, 2006 (TW) 95149692

(51) Int. Cl. G02F 1/1343

(52) U.S. Cl. 349/144

(57) ABSTRACT

An exemplary multi-domain vertical alignment liquid crystal display (1) includes a common electrode, a pixel electrode and a liquid crystal layer sandwiched between the common electrode and the pixel electrode. The common electrode, the pixel electrode and the liquid crystal layer are regularly divided into pixel regions. Each pixel region includes a first sub-pixel region (201), a second sub-pixel region (202), a third sub-pixel region (203), and a fourth sub-pixel region (204). Each sub-pixel region includes a protrusion structure (116, 117) at an inner surface of the common electrode. The first sub-pixel region and the third sub-pixel region define a first slit (126) in the pixel electrode, respectively, and have different data voltages applied thereto. The second sub-pixel region and the fourth sub-pixel region define a second slit (127) in the pixel electrode, respectively, and have different data voltages applied thereto.

### FIELD OF THE INVENTION

The present invention relates to multi-domain vertical alignment liquid crystal displays (LCDs).

### GENERAL BACKGROUND

Since liquid crystal displays are thin and light, consume relatively little electrical power, and do not cause flickering, they have helped spawn product markets such as for laptop personal computers. In recent years, there has also been great demand for liquid crystal displays to be used as computer monitors and even televisions, both of which are larger than the liquid crystal displays of laptop personal computers. Such large-sized liquid crystal displays in particular require that an even brightness and contrast ratio prevail over the entire display surface, regardless of observation angle.

Because the conventional twisted nematic (TN) mode liquid crystal displays cannot easily satisfy these demands, a variety of improved liquid crystal displays have recently been developed. They include in-plane switching (IPS) mode liquid crystal displays, optical compensation TN mode liquid crystal displays, and multi-domain vertical alignment (MVA) mode liquid crystal displays. In multi-domain vertical alignment mode liquid crystal displays, each pixel is divided into multiple regions. Liquid crystal molecules of the pixel are vertically aligned when no voltages are applied, and are inclined in different directions in when voltages are applied. Typical multi-domain vertical alignment mode liquid crystal displays have four domains in a pixel, and use protrusions and/or slits to form the domains.

Referring to FIG. 6, a typical multi-domain vertical alignment liquid crystal display 6 includes a first substrate assembly 61, a second substrate assembly 62 parallel to the first substrate assembly 61, and a liquid crystal layer 63 sandwiched therebetween. The liquid crystal layer 63 includes a plurality of liquid crystal molecules 631 having negative dielectric anisotropy.

The first substrate assembly 61 includes an upper polarizer 611, a first transparent substrate 612, a color filter 613, a common electrode 614, a first alignment film 615 arranged in that order from top to bottom, and a plurality of first protrusions 616. The first protrusions 616 are arranged on an inner surface of the first alignment film 615, and are V-shaped. The second substrate assembly 62 includes a lower polarizer 621, a second transparent substrate 622, a plurality of pixel electrodes 623, a second alignment film 624 arranged in that order from bottom to top, and a plurality of second protrusions 626. The second protrusions 626 are arranged on an inner surface of the second alignment film 624, and are V-shaped. The first protrusions 616 and the second protrusions 626 are arranged alternately.

Referring to FIG. 7, when the liquid crystal display 6 is in an off state, the liquid crystal molecules 631 orient perpendicularly to the first substrate assembly 61. In operation, incident light beams become linearly-polarized light beams after passing through the lower polarizer 621. The polarizing directions of the linearly-polarized light beams passing through the liquid crystal layer 63 do not change, because the light beams transmit along the long axes of the liquid crystal molecules 631. Accordingly, the light beams passing through the liquid crystal layer 63 cannot pass though the upper polarizer 611 that has a polarizing axis perpendicular to that of the lower polarizer 621. As a result, the liquid crystal display 6 displays a black image.

Referring to FIG. 8, when the liquid crystal display 6 is in an on state, voltages are applied thereto, and the common electrode 614 and pixel electrodes 623 generate an electric field perpendicular to the first substrate assembly 61. Because the liquid crystal molecules 631 have negative dielectric anisotropy, they are inclined to orient parallel to the first substrate assembly 61. While the protrusions 616, 626 affect the orientations of the liquid crystal molecules 631, such that the liquid crystal molecules 631 form inclined alignments perpendicularly to the inclined surfaces of the protrusions 616, 626. Referring also to FIG. 9, the liquid crystal molecules 631 orient in four directions A, B, C and D.

In operation, incident light beams become linearly-polarized light beams after passing through the lower polarizer 621. Because of birefringence of the liquid crystal molecules 631, the polarizing directions of the linearly-polarized light beams change after the light beams pass through the liquid crystal layer 63. Accordingly, part of the light beams pass through the upper polarizer 611. Therefore, the liquid crystal display 6 forms an image with a desired brightness.

Because the liquid crystal molecules 631 are oriented in four directions, color shift that would otherwise be manifest in images displayed by the liquid crystal display 6 is compensated. In particularly, the liquid crystal display 6 has a more even display performance along four different viewing directions corresponding to the four directions. That is, the liquid crystal display 6 attains four domains.

However, the four-domain configuration can only compensate visual performance in four directions.

What is needed, therefore, is a multi-domain vertical alignment liquid crystal display having more domains that can provide uniform display in more viewing directions.

### SUMMARY

In one preferred embodiment, a multi-domain vertical alignment liquid crystal display includes a common electrode, a pixel electrode and a liquid crystal layer sandwiched between the common electrode and the pixel electrode. The common electrode, the pixel electrode and the liquid crystal layer are regularly divided into a plurality of pixel regions. Each pixel region includes a first sub-pixel region, a second sub-pixel region, a third sub-pixel region and a fourth sub-pixel region. Each sub-pixel region comprises a protrusion structure at an inner surface of the common electrode. The first sub-pixel region and the third sub-pixel region define a first slit in the pixel electrode, respectively, and have different data voltages applied thereto. The second sub-pixel region and the fourth sub-pixel region define a second slit in the pixel electrode, respectively, and have different data voltages applied thereto.

Other novel features, advantages and aspects will become more apparent from the following detailed description when taken in conjunction with the accompanying drawings.

### BRIEF DESCRIPTION OF THE DRAWINGS

FIG. 1 is a side, cross-sectional view of part of a multi-domain vertical alignment liquid crystal display according to a first embodiment of the present invention.

FIG. 2 is a top plan view of certain parts of the multi-domain vertical alignment liquid crystal display of FIG. 1, the multi-domain vertical alignment liquid crystal display including a plurality of pixel regions each having four sub-pixel regions.

FIG. 3 is a cross-sectional view taken along line III-III of FIG. 2.

FIG. 4 is a top plan view of one of the sub-pixel regions of FIG. 2, showing orientations of liquid crystal molecules thereat.

FIG. 5 is similar to FIG. 2, but showing a corresponding view in the case of part of a multi-domain vertical alignment liquid crystal display according to a second embodiment of the present invention.

FIG. 6 is a side, cross-sectional view of a conventional multi-domain vertical alignment liquid crystal display, the multi-domain vertical alignment liquid crystal display including a plurality of liquid crystal molecules.

FIG. 7 is an exploded, isometric view of the multi-domain vertical alignment liquid crystal display of FIG. 6, showing alignments of the liquid crystal molecules in an off state.

FIG. 8 is similar to FIG. 7, but showing alignments of the liquid crystal molecules in an on state.

FIG. 9 is a top plan view of certain parts of the multi-domain vertical alignment liquid crystal display of FIG. 6, showing alignments of the liquid crystal molecules in an off state.

### DETAILED DESCRIPTION OF PREFERRED EMBODIMENTS

Reference will now be made to the drawings to describe the preferred embodiments in detail.

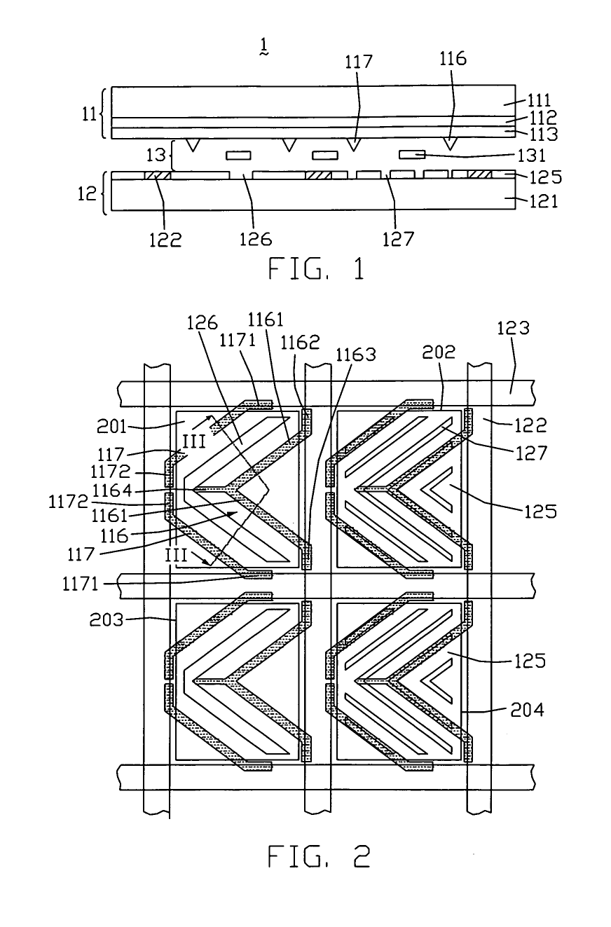

Referring to FIG. 1 and FIG. 2, a multi-domain vertical alignment liquid crystal display 1 according to a first embodiment of the present invention is shown. The liquid crystal display 1 includes a first substrate assembly 11, a second substrate assembly 12 parallel to the first substrate assembly 11, and a liquid crystal layer 13 sandwiched therebetween. The liquid crystal layer 13 includes a plurality of liquid crystal molecules 131 having negative dielectric anisotropy.

The first substrate assembly 11 includes a first transparent substrate 111, a color filter 112, and a common electrode 113 arranged in that order from top to bottom, and a plurality of first protrusions 116 and a plurality of second protrusions 117. The first protrusions 116 and the second protrusions 117 are arranged on an inner surface of the common electrode 113. The color filter 112 includes a plurality of red filters (R), a plurality of green filters (G), and a plurality of blue filters (B).

The second substrate assembly 12 includes a second transparent substrate 121, a plurality of data lines 122 that are parallel to each other and that each extend along a first direction, a plurality of gate lines 123 that are parallel to each other and that each extend along a second direction orthogonal to the first direction, and a plurality of pixel electrodes 125.

A smallest area defined by two adjacent data lines 122 and two adjacent gate lines 123 is defined as a sub-pixel region. A pixel electrode 125 is disposed at the sub-pixel region. Each three sequential data lines 122 and each three sequential gate lines 123 define a retangular-shaped pixel region (not labeled). A pixel region corresponds to a red filter, a green filter, or a blue filter of the color filter 112, and includes four sub-pixel regions. The four sub-pixel region are defines as a first sub-pixel region 201, a second sub-pixel region 202, a third sub-pixel region 203, and a fourth sub-pixel region 204, respectively.

The first sub-pixel region 201 includes a first protrusion 116 and two second protrusions 117 arranged on the common electrode 113. The first protrusion 116 and the second protrusions 117 each have a triangular cross-sectional shape. The first protrusion 116 is arranged along a V-shaped path and includes two strips 1161. The two strips 1161 both extend from a center portion of the first sub-pixel region 201 to two right corners thereof. The first protrusion 116 further includes a first extending portion 1162, a second extending portion 1163, and a third extending portion 1164. The first extending portion 1162 and the second extending portion 1163 extend from two ends of the two strips 1161 in the corners, and are parallel to the data lines 122. The third extending portion 1164 extends from the center portion of the first sub-pixel region 201, and is parallel to the gate lines 123.

The second protrusions 117 are strip-shaped, and are parallel to the two strips 1161 of the first protrusion 116, respectively. Each second protrusion 117 includes a fourth extending portion 1171 and a fifth extending portion 1172 that extend from two ends thereof. The fourth extending portion 1171 is parallel to the gate lines 123. The fifth extending portion 1172 is parallel to the data lines 122.

The first sub-pixel region 201 further defines a first slit 126 in the pixel electrode 125 along a V-shaped path. The first slit 126 is defined alternately with the first protrusion 116 and the second protrusions 117 in the first substrate assembly 11.

The second sub-pixel region 202 is similar to the first sub-pixel region 201. However, the second sub-pixel region 202 defines a plurality of second slits 127 arranged alternately. The second slits 127 are defined along V-shaped paths similar to the first slits 126. However, a width of the second slit 127 is less than a width of the first slit 126.

The third sub-pixel region 203 is similar to the first sub-pixel region 201. The fourth sub-pixel region 204 is similar to the second sub-pixel region 202.

In a frame, the pixel electrodes 125 in the first sub-pixel region 201 and in the second sub-pixel region 202 have first data voltages applied thereto. The pixel electrodes 125 in the third sub-pixel region 203 and in the fourth sub-pixel region 204 have second data voltages applied thereto. The first data voltages are different from the second data voltages.

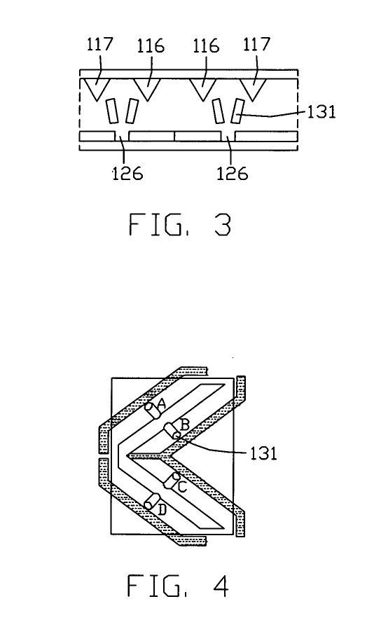

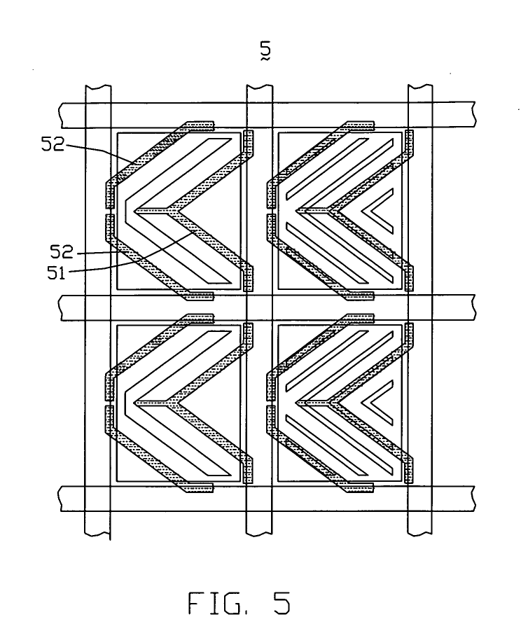

Referring to FIG. 3, when the liquid crystal display 1 is in an on state, voltages are applied thereto. In the first sub-pixel region 201, the common electrode 113 and pixel electrodes 125 generate a fringe electric field near the first slit 126. The fringe electric field is inclined. Because the liquid crystal molecules 131 have negative dielectric anisotropy, they are inclined to orient perpendicular to the direction of the fringe electric field. In addition to the effects of the first protrusions 116 and the second protrusions 117, the liquid crystal molecules 131 orient with an angle relative to the second substrate assembly 12. Referring also to FIG. 4, the liquid crystal molecules 131 orient in four directions A, B, C and D.

Liquid crystal molecules 131 in the second sub-pixel region 202, the third sub-pixel region 203, and the fourth sub-pixel region 204 orient in four directions A, B, C and D similar to those of the first sub-pixel region 201. However, the first sub-pixel region 201 defines the first slit 126, the second sub-pixel region 202 defines the second slits 127, and a width of the second slit 127 is less than a width of the first slit 126. Thus strengths of the fringe electric fields in the first sub-pixel region 201 are different from those in the second sub-pixel region 202. Similarly, strengths of the fringe electric fields in the third sub-pixel region 203 are different from those in the fourth sub-pixel region 204. Thus, angles between the liquid crystal molecules 131 and the second substrate assembly 12 in the first sub-pixel region 201 are different from those in the second sub-pixel region 202. Angles between the liquid crystal molecules 131 and the second substrate assembly 12 in the third sub-pixel region 203 are different from those in the fourth sub-pixel region 204.

Furthermore, the voltages applied to the first sub-pixel region 201 and the second pixel region 202 are different from the voltages applied to the third sub-pixel region 203 and the fourth pixel region 204. Thus, the strengths of the fringe electric fields in the first sub-pixel region 201 are different from those in the third sub-pixel region 203. Similarly, the strengths of the fringe electric fields in the second sub-pixel region 202 are different from those in the fourth sub-pixel region 204. Thus, angles between the liquid crystal molecules 131 and the second substrate assembly 12 in the first sub-pixel region 201 are different from those in the third sub-pixel region 203. Angles between the liquid crystal molecules 131 and the second substrate assembly 12 in the second sub-pixel region 202 are different from those of the fourth sub-pixel region 204.

In a word, the strengths of the fringe electric fields in the four sub-pixel regions 201, 202, 203, 204 are different from each other in a frame, thus angles between the liquid crystal molecules 131 and the second substrate assembly 12 in the four sub-pixel region 201, 202, 203, 204 are different from each other in a frame. Therefore, the liquid crystal display 1 has 16 domains.

Unlike conventional multi-domain liquid crystal displays, the multi-domain vertical alignment liquid crystal display 1 attains a visual effect that is an overall result of sixteen domains. Therefore, the multi-domain vertical alignment liquid crystal display 1 has improved display quality.

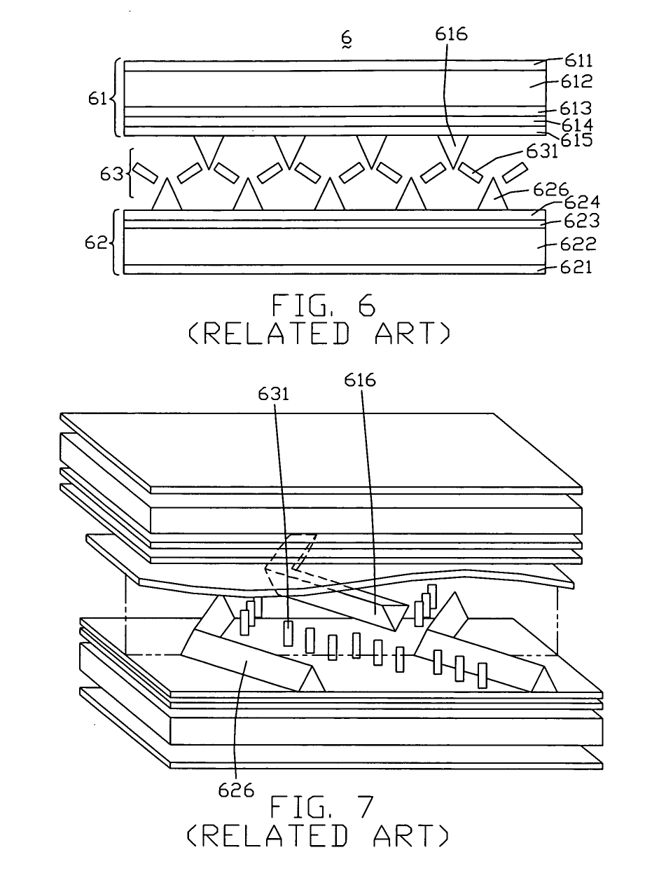

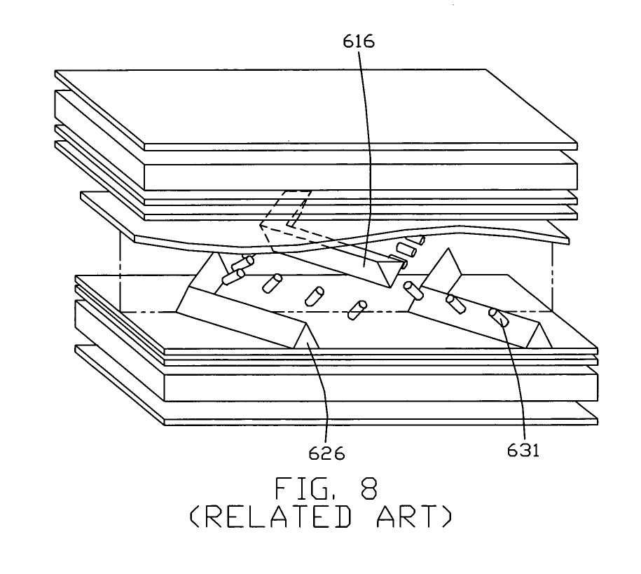

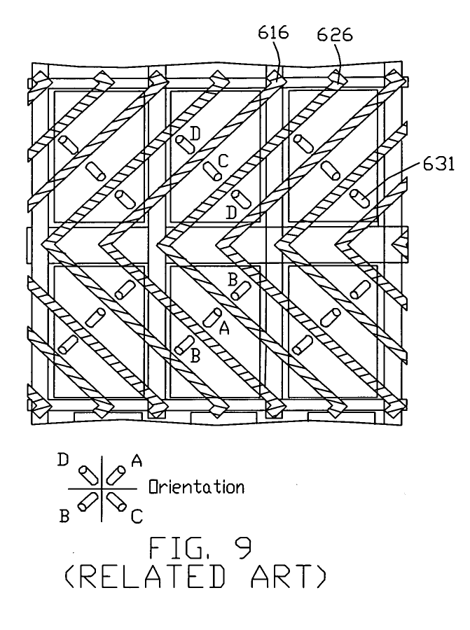

Referring to FIG. 5, a multi-domain vertical alignment liquid crystal display 5 according to a second embodiment of the present invention is shown. The multi-domain vertical alignment liquid crystal display 5 is similar to the multi-domain vertical alignment liquid crystal display 1 of the first embodiment. However, a common electrode (not shown) thereof defines a plurality of third slits 51 and a plurality of fourth slits 52. The third slits 51 are arranged similar to the first protrusions 116 in the multi-domain vertical alignment liquid crystal display 1. The fourth slits 52 are arranged similar to the second protrusions 117 in the multi-domain vertical alignment liquid crystal display 1.

Further or alternative embodiments may include the following. In one example, the color filter can further includes a plurality of white filters arranged alternately with the red filters, the green filters and the blue filters. In another example, the first sub-pixel region and the second sub-pixel region can have identical structures, but have different voltages applied thereto. The third sub-pixel region and the fourth sub-pixel region can have identical structures, but have different voltages applied thereto.

It is to be further understood that even though numerous characteristics and advantages of the present embodiments have been set out in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A multi-domain vertical alignment liquid crystal display comprising:
a common electrode;
a pixel electrode; and
a liquid crystal layer sandwiched between the common electrode and the pixel electrode;
the liquid crystal display being regularly divided into a plurality of pixel regions, each pixel region comprising a first sub-pixel region, a second sub-pixel region, a third sub-pixel region, and a fourth sub-pixel region, each sub-pixel region comprising a protrusion structure at an inner surface of the common electrode,
the first sub-pixel region and the third sub-pixel region defining a first slit in the pixel electrode, respectively, and having different data voltages applied thereto, and
the second sub-pixel region and the fourth sub-pixel region defining a second slit in the pixel electrode, respectively, and having different data voltages applied thereto.

2. The multi-domain vertical alignment liquid crystal display as claimed in claim 1, where the protrusion structure comprises a first protrusion, the first protrusion being V-shaped.

3. The multi-domain vertical alignment liquid crystal display as claimed in claim 2, wherein the first protrusion has a triangular cross-sectional shape.

4. The multi-domain vertical alignment liquid crystal display as claimed in claim 2, wherein the first protrusion comprises two strips, the two sides extending from a center of the sub-pixel region to two corners of the sub-pixel region.

5. The multi-domain vertical alignment liquid crystal display as claimed in claim 4, wherein the first protrusion further comprises a first extending portion, the first extending portion extend from the center part of the sub-pixel region and along an axis of symmetry of the sub-pixel region.

6. The multi-domain vertical alignment liquid crystal display as claimed in claim 2, wherein the protrusion structure further comprises two second protrusions, the second protrusions being arranged parallel to two strips of the first protrusion, respectively.

7. The multi-domain vertical alignment liquid crystal display as claimed in claim 6, wherein the second protrusions have triangular cross-sectional shapes.

8. The multi-domain vertical alignment liquid crystal display as claimed in claim 6, wherein each second protrusion comprises a second extending portion parallel to an axis of symmetry of the sub-pixel region, and a third extending portion parallel to another axis of symmetry of the sub-pixel region.

9. The multi-domain vertical alignment liquid crystal display as claimed in claim 1, wherein the first slit is defined along a V-shaped path.

10. The multi-domain vertical alignment liquid crystal display as claimed in claim 1, wherein the second slit is defined along a V-shaped path.

11. The multi-domain vertical alignment liquid crystal display as claimed in claim 1, wherein a width of the first slit is greater than a width of the second slit.

12. The multi-domain vertical alignment liquid crystal display as claimed in claim 1, wherein the first sub-pixel region or the second sub-pixel region defines at least another first slit.

13. The multi-domain vertical alignment liquid crystal display as claimed in claim 1, further comprising a color filter, the color filter comprising a plurality of red filters, a plurality of green filters, and a plurality of blue filters, each pixel region corresponding to a respective one of the filters.

14. The multi-domain vertical alignment liquid crystal display as claimed in claim 1, further comprising a color filter, the color filter comprising a plurality of red filters, a plurality of green filters, a plurality of blue filters, and a plurality of white filters, each pixel region corresponding to a respective one of the filters.

15. A multi-domain vertical alignment liquid crystal display comprising:
a first substrate assembly comprising a protrusion structure,
a second substrate assembly comprising a plurality of gate lines that are parallel to each other and that extend along a first direction, a plurality of gate lines that are parallel to each other and that extend along a second direction, and a plurality of pixel electrodes arranged in smallest areas defined by each adjacent two gate lines and two data lines,
three sequential gate lines and three sequential data lines together with four pixel electrodes thereof forming a pixel region, and two of the four pixel electrodes defining a first V-shaped slit, respectively, and having two different data voltages applied thereto, the other two pixel electrodes defining a second V-shaped slit, respectively, and having two different data voltages applied thereto.

16. The multi-domain vertical alignment liquid crystal display as claimed in claim 15, wherein the first V-shaped slit is defined from a center part of the pixel electrode to two corners of the pixel electrode.

17. The multi-domain vertical alignment liquid crystal display as claimed in claim 15, wherein the protrusion structure comprises a plurality of first protrusions and a plurality of second protrusions.

18. The multi-domain vertical alignment liquid crystal display as claimed in claim 17, wherein each first protrusion corresponds to a pixel electrode, and the first protrusion is V-shaped and has two strips.

19. The multi-domain vertical alignment liquid crystal display as claimed in claim 18, wherein each two protrusions correspond to a pixel electrode, and the second protrusions are parallel to the two strips of the first protrusion.

20. The multi-domain vertical alignment liquid crystal display as claimed in claim 15, wherein the first substrate assembly further comprises a color filter, the color filter comprising a plurality of red filters, a plurality of green filters and a plurality of blue filters, each pixel region corresponding to a respective one of the filters.
